(19) United States
(12) Patent Application Publication
(10) Pub. No.: US 2026/0210439 A1
(43) Pub. Date: Jul. 23, 2026

(54) SEAL FOR A BEARING AND BEARING COMPRISING THE SEAL

(71) Applicant: Aktiebolaget SKF, Goteborg (SE)

(72) Inventors: Wei LI, Shanghai (CN); Xue YING, Kunshan (CN); Hongyuan AN, Shanghai (CN); Yafen CHEN, Shanghai (CN)

(21) Appl. No.: 19/451,175

(22) Filed: Jan. 16, 2026

(30) Foreign Application Priority Data
Jan. 23, 2025 (CN) 202510108978.8

(51) Int. Cl. F16J 15/3204; F16C 33/78; F16J 15/3284

(52) U.S. Cl. CPC F16J 15/3204; F16C 33/7856; F16J 15/3284

(57) ABSTRACT

The present disclosure provides a seal for fitting between inner and outer rings of a bearing. The seal includes a sealing lip having an annular end face extending generally in the axial direction and a first inclined side face inclined with respect to the axial direction. The first inclined side face faces the inner space of the bearing and is connected to the annular end face. The first inclined side face includes a contact portion located near the annular end face for contacting the seal surface of the inner or outer ring. The sealing lip structure solves the problem of easy tearing and damage of the sealing lip, and also avoids the risk of the parting line falling off. The present disclosure further optimizes the loading and sealing performance of the sealing lip and the seal as a whole, not only increasing seal life but also improving bearing operation.

### CROSS-REFERENCE TO RELATED APPLICATION

This application claims priority to Chinese Patent Application No. 202510108978.8, filed January 23, 2025, the entirety of which is hereby incorporated by reference.

### FIELD

The present disclosure relates to a seal for a bearing and a bearing comprising the seal.

### BACKGROUND

Bearings are widely used in various fields. Bearings typically include seal(s) disposed between the inner ring and the outer ring. The seal typically includes a sealing lip for contacting the rings of the bearing (the inner ring and the outer ring may be either referred to as the ring) to provide a seal for the inner space of the bearing to prevent external contaminants from entering the inner space of the bearing, and to prevent lubricant in the inner space of the bearing from leaking, as shown in FIG. 4.

The sealing lip of the seal is usually formed by a molding process. However, in the prior art, due to limitations of the production process, the tip of the sealing lip has a sharp edge (as shown by the dashed circle in FIG. 4). During the molding process, a parting line may form at this sharp edge, and the parting line may be squeezed and rubbed against the ring surface. In this case, during long-term contact and relative movement between the sealing lip and the ring, the parting line may fall off and even cause tearing of the entire sealing lip.

On the other hand, after the seal is assembled into the bearing, the sharp edge will come into contact with and be deformed by the ring, in which case the sharp edge will be subjected to a large reaction force coming from the ring, which directly affects the friction force to which the sharp edge is subjected and will affect the rotation of the bearing and the life of the seal.

Accordingly, there is a desire in the art for a seal that overcomes the above problems.

### SUMMARY

In response to the above-mentioned problems and needs, the present disclosure proposes a new technical solution, which solves the above problems and brings other technical effects by adopting the following technical features.

The present disclosure provides a seal for fitting between an inner ring and an outer ring of a bearing, the bearing having a radial direction and an axial direction, the seal comprising: a sealing lip having: an annular end face extending generally in the axial direction; and a first inclined side face inclined with respect to the axial direction, facing the inner space of the bearing, and connected to the annular end face, the first inclined side face including a contact portion located near the annular end face for contacting the seal surface of the inner ring or the outer ring.

The present disclosure also provides a bearing comprising the seal as previously described.

The sealing lip structure of the seal of the present disclosure is optimally designed to not only solve the problem of easy tearing and damage of the sealing lip, but also avoid the risk of the parting line falling off. At the same time, the present disclosure further optimizes the loading and sealing performance of the sealing lip and the seal as a whole, not only increasing seal life but also improving bearing operation.

### BRIEF DESCRIPTION OF DRAWINGS

FIG. 1 shows a seal and a bearing fitted with the seal according to a preferable embodiment of the present disclosure;

FIG. 2 is an enlarged view of a sealing lip of the seal according to a preferable embodiment of the present disclosure, showing the sealing lip before and after assembly;

FIG. 3 is an enlarged view of the sealing lip of the seal according to a preferable embodiment of the present disclosure, showing the relevant parameters;

FIG. 4 shows a seal and a bearing fitted with the seal according to the prior art.

### DETAILED DESCRIPTION

In order to make the purpose, technical solutions and advantages of the technical solutions of the present disclosure clearer, the technical solutions of the embodiments of the present disclosure will be clearly and completely described below with reference to the accompanying drawings of specific embodiments of the present disclosure. The same reference numbers in the drawings represent the same parts. It should be noted that the described embodiments are some, not all, of the embodiments of the present disclosure. Based on the described embodiments of the present disclosure, all other embodiments obtained by those of ordinary skill in the art without creative efforts fall within the scope of protection of the present disclosure.

Possible implementations within the scope of protection of the present disclosure may have fewer components than the embodiments illustrated in the figures, have other components not illustrated in the figures, different components, differently arranged components or differently connected components, etc. Furthermore, two or more components in the figures may be implemented within a single component, or a single component shown in the figures may be implemented as multiple separate components.

Unless otherwise defined, technical or scientific terms used herein shall have their ordinary meaning as understood by a person of ordinary skill in the art to which this disclosure belongs. The terms "first", "second" and similar words used in the specification and claims of this disclosure do not indicate any order, quantity or importance, but are only used to distinguish different components. When the number of components is not stated, the number of components can be one or more; likewise, words such as "a," "the," "said," and similar words do not necessarily indicate a quantitative limitation. Words such as "include" or "comprise" mean that the elements or items appearing before the word include the elements or items listed after the word and their equivalents, without excluding other elements or items. Words such as "installation", "setting", "connection" or "couple" are not limited to physical or mechanical installation, setting, and connection, but may include electrical installation, setting, and connection, whether direct or indirect. "Up", "down", "left", "right", etc. are only used to represent the relative orientation relationship when the device is used or the orientation relationship shown in the drawings. When the absolute position of the described object changes, the relative position Relationships may also change accordingly.

For ease of explanation, the direction of the rotational axis of the bearing is referred to herein as the axial direction, and the direction perpendicular to the axial direction is referred to as the radial direction. The term "inward" means towards the inside of the bearing, and conversely, the term "outer" means towards the outside of the bearing.

In view of the aforementioned problems faced by prior art seals, the present disclosure provides a seal having an optimized sealing lip structure.

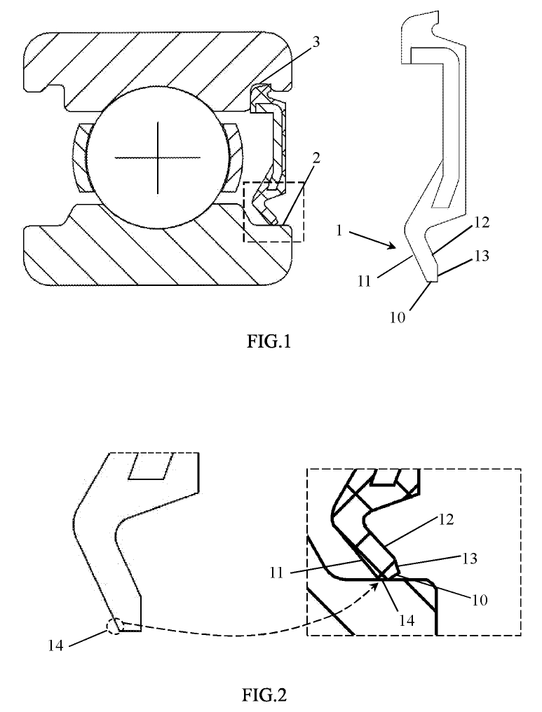

Specifically, referring to FIGS. 1-3, a seal according to a preferable embodiment of the present disclosure is adapted to fit between an inner ring and an outer ring of a bearing. For example, the seal may also include a skeleton, rubber, polymer, etc. material overmolded on the skeleton. The seal of the preferable embodiment shown in the drawings may include a sealing lip 1 for contact with the sealing surface 2 of the inner ring, and a sealing edge portion fitting into a sealing groove 3 of the outer ring.

Of course, according to other embodiments not shown, the inner ring may be provided with a sealing groove while the outer ring may be provided with a sealing surface, and accordingly, structure of a seal may be mirrored with that shown in the drawings, so that the sealing lip of the seal is in contact with the sealing surface of the outer ring.

Continuing with reference to FIGS. 1-3, according to a preferable embodiment of the present disclosure, the sealing lip 1 includes an annular end face 10 and a first inclined side face 11.

The annular end face 10 extends substantially in the axial direction, so that the annular end face 10 is formed as a substantially cylindrical surface. It should be understood that "substantially" here means that the annular end face 10 is not strictly parallel to the axial direction, but that due to manufacturing tolerances etc., the annular end face 10 may be at a small angle relative to the axial direction (e.g. approximately 0-3 degrees).

The first inclined side face 11 is inclined relative to the axial direction, faces the inner space of the bearing and is connected to the annular end face 10. It should be understood that the "internal space of the bearing” here is the internal space used to accommodate the rolling elements and lubricant of the bearing. The first inclined side face 11 includes a contact portion 14 located near the annular end face 10 for contact with the sealing surface 2 of the inner ring.

Through the above structural optimization of the sealing lip 1, during the assembly process of the seal into the bearing, the annular end face 10 will firstly contact the sealing surface 2 of the inner ring and be squeezed and deformed. As the sealing lip 1 is further compressed to deform, the annular end face 10 will be deformed away from the sealing surface 2, and the contact portion 14 of the first inclined side face 11 will come into contact with the sealing surface 2 and finally reach the assembled state shown in the enlarged view in FIG. 2.

It can be seen that, as compared to the prior art shown in FIG. 4, the present disclosure proposes a completely different sealing lip structure. The sealing lip according to the disclosure is not in contact with the sealing surface of the inner ring or the outer ring via any sharp edge, but is in contact with the sealing surface via a contact portion of the first inclined side face. This structure of the sealing lip provides a more flexible design option for the mold used to manufacture the seal, so that the parting line may be set at a position where it does not contact the sealing surface (as described in detail later), avoiding tearing and damage of the sealing lip, to avoid risks such as the parting line falling off.

In addition, since the sealing lip is compressed and deformed by the sealing surface after assembly of the seal, it is subjected to reaction forces coming from the sealing surface, which directly affect the operation of the bearing and the life of the seal. The sealing lip structure according to the present disclosure further optimizes the loading situation of the entire seal.

After research, the shape of the sealing lip of the prior art shown in FIG. 4 after compression and deformation is not ideal, so that the thickness of the portion of the sealing lip in contact with the sealing surface is small, but the reaction force it receives is very large, which causes problems such as easy tearing and damage of the sealing lip.

The reaction force experienced by the optimized sealing lip structure according to the present disclosure after compression and deformation is significantly reduced (under the same conditions, compared with the prior art of FIG. 4, the reaction force experienced by the sealing lip in the embodiment of FIGS. 1-3 is reduced by 70% ~ 85%), and the thickness of the contact portion in contact with the sealing surface is larger, so the strength is improved and is less likely to be damaged. Further studies have found that the contact force (or pressure) per unit area of the contact portion of the first inclined side face can be increased, thereby significantly improving the sealing effect of the sealing lip and preventing material exchange between the inside and outside of the bearing.

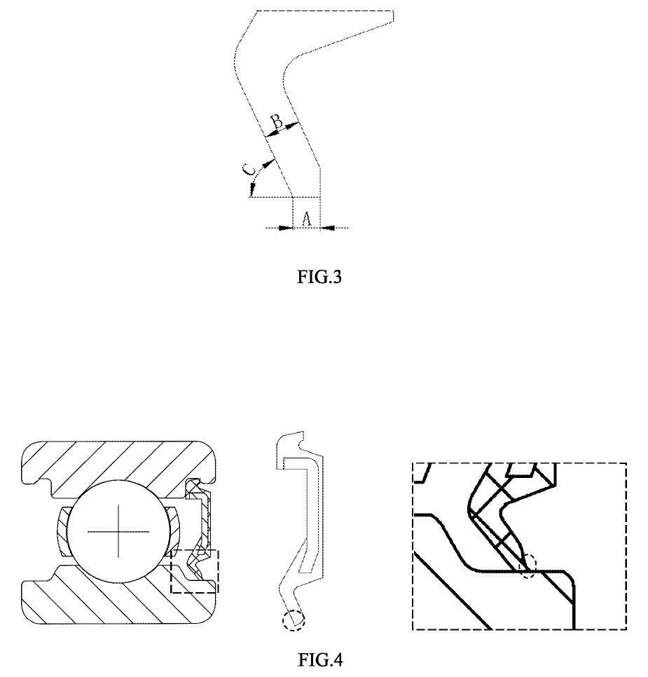

Preferably, the sealing lip 1 also includes a second inclined side face 12 located on the opposite side to the first inclined side face 11 and connected to an annular side face 13. Further preferably, the first inclined side face 11 and the second inclined side face 12 are parallel and define a thickness B of the sealing lip 1 therebetween, and the thickness B is 0.3 ~ 0.7 mm, preferably 0.4 ~ 0.6 mm, as shown in FIG. 3.

According to a preferable embodiment, the sealing lip 1 may also include an annular side face 13 located on the side opposite to the first inclined side face 11, extending generally in the radial direction, and connected to the annular end face 10. It should be understood that "substantially" here means that the annular side face 13 is not strictly parallel to the radial direction, but that the annular side face 13 may be at a small angle (e.g. approximately 0 ~ 3 degrees) relative to the radial direction due to manufacturing tolerances or the like.

By providing such an annular side face 13, the formation of a sharp edge between the annular side face 13 and the annular end face 10 can be avoided, which facilitate avoiding quality problems when the seal is demolded and reducing the difficulty of manufacture of the mold.

In addition, by providing such an annular side face 13, a more flexible design option may be further provided for the mold design of the seal, and in particular, the parting line may be located at a more reasonable position through mold design. For example, the parting line of the sealing lip 1 may be located on the annular side face 13, or at the location where the annular side face 13 and the second inclined side face 12 are connected, or at the location where the annular side face 13 and the annular end face 10 are connected. By arranging the parting line at the above-mentioned location, after the seal is assembled, the parting line will not contact the sealing surface 2 in any way, thereby avoiding the problem of the parting line falling off.

Furthermore, the present disclosure also proposes not to provide any parting line at locations that may come into contact with the sealing surface 2. Specifically, there is no parting line on the first inclined side face 11, on the annular end face 10, or at the location where the first inclined side face 11 and the annular end face 10 are connected.

According to a preferable embodiment, the width A of the annular end face 10 is 0.1 ~ 0.5 mm, preferably 0.2 ~ 0.35 mm. The angle at which the first inclined side face 11 is inclined relative to the axial direction ranges from 45 ~ 75 degrees, preferably 55 ~ 65 degrees, as shown in angle C in FIG. 3. According to another preferable embodiment, the ratio of the width A of the annular end face (10) to said thickness B may be 0.35 ~ 0.70, preferably 0.4 ~ 0.55. The above design ensures sealing performance while balancing strength and flexibility of the sealing lip.

Further, the present disclosure provides a bearing, which includes the seal as described above.

As mentioned before, the first inclined side face 11 of the sealing lip 1 of the seal has a contact portion 14 through which the first inclined side face 11 is in contact with the sealing surface 2.

To sum up, the present disclosure provides a seal whose sealing lip structure is optimally designed to not only solve the problem of easy tearing and damage of the sealing lip, but also avoid the risk of the parting line falling off. At the same time, the present disclosure further optimizes the loading and sealing performance of the sealing lip and the seal as a whole, not only increasing life of the seal but also improving bearing operation.

The exemplary embodiments of the present disclosure have been described in detail above with reference to preferable embodiments. However, those skilled in the art will understand that various modifications and modifications can be made to the above specific embodiments without departing from the concept of the present disclosure. Modifications, and various technical features and structures proposed in the present disclosure can be made in various combinations without exceeding the scope of protection of the present disclosure, which is determined by the appended claims.

What is claimed is:

1. A seal for fitting between an inner ring and an outer ring of a bearing, the bearing having a radial direction and an axial direction, the seal comprising:
a sealing lip having:
an annular end face extending generally in an axial direction; and
a first inclined side face inclined with respect to the axial direction, facing an inner space of the bearing and connected to the annular end face, the first inclined side face comprising a contact portion located near the annular end face for contacting the sealing surface of the inner ring or the outer ring.

2. The seal according to claim 1, wherein the sealing lip further comprises an annular side face located on a side opposite to the first inclined side face, extending generally in a radial direction, and connected to the annular end face.

3. The seal according to claim 2, wherein the sealing lip further comprises a second inclined side face located on the side opposite to the first inclined side face and connected to the annular side face.

4. The seal according to claim 3, wherein the sealing lip is formed by a molding process and a parting line of the sealing lip is located on the annular side face or at a location where the annular side face and the second inclined side face are connected or at a location where the annular side face and the annular end face are connected.

5. The seal according to claim 3, wherein there is no parting line on the first inclined side face, on the annular end face, and where the first inclined side face and the annular end face are connected.

6. The seal according to claim 3, wherein the first inclined side face and the second inclined side face are parallel and define therebetween a thickness of the sealing lip, and the thickness is 0.3-0.7 mm.

7. The seal according to claim 6, wherein the thickness is 0.4-0.6 mm.

8. The seal according to claim 1, wherein the width of the annular end face is 0.1-0.5 mm.

9. The seal according to claim 8, wherein the width of annular end face is 0.2-0.35 mm.

10. The seal according to claim 6, wherein the ratio of the width of the annular end face to the thickness is 0.35-0.70.

11. The seal according to claim 10, wherein the ration of the width of the annular end face to the thickness is 0.4-0.55.

12. The seal according to claim 1, wherein the angle at which the first inclined side face is inclined relative to the axial direction ranges from 45-75 degrees.

13. The seal according to claim 12, wherein the angle at which the first inclined side face is inclined relative to the axial direction ranges from 55-65 degrees.

14. A bearing comprising the seal according to claim 1.
